(19) United States
(12) Patent Application Publication
(10) Pub. No.: US 2018/0052585 A9
(43) Pub. Date: Feb. 22, 2018

(54) Data input and transmission of communication request priority to recipient

(71) Applicant: Kenneth Robert Kukkee, Thunder Bay (CA)

(72) Inventor: Kenneth Robert Kukkee, Thunder Bay (CA)

(21) Appl. No.: 14/993,070

(22) Filed: Jan. 11, 2016

Related U.S. Application Data
(60) Provisional application No. 62/176,520, filed on Feb. 23, 2015.

(51) Int. Cl. G06F 3/0481; H04L 12/58; G06F 3/0484; G06F 3/16

(52) U.S. Cl. CPC G06F 3/04817; G06F 3/167; G06F 3/04847; H04L 51/26

(57) ABSTRACT

Enhanced communication between mobile device users is enabled by composing and transmitting priority-indicated communication requests to remote devices. Priority level is selectively indicated by data input on a touch-screen display through selection, manipulation and setting of adjustments using various colors, sizes and proportions of in-fill of graphic icons. Message transmitted and displayed to recipient clearly indicates priority of communication request.

### CROSS-REFERENCE TO RELATED APPLICATIONS

This nonprovisional patent application claims prior benefit of filing date of a provisional patent application:

Application No. 62/176,520 CONFIRMATION NO. 7971

Filing date Feb. 23, 2015

Name of applicant Kenneth Robert Kukkee

Provisional application Title of invention: “Call Request” computer software application for mobile devices

### STATEMENT REGARDING FEDERALLY SPONSORED RESEARCH OR DEVELOPMENT

Not federally sponsored

### THE NAMES OF THE PARTIES TO A JOINT RESEARCH AGREEMENT

None.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

None

### STATEMENT REGARDING PRIOR DISCLOSURES BY THE INVENTOR OR A JOINT INVENTOR

### BACKGROUND OF THE INVENTION

People consistently need telephone communication with others for a multitude of reasons. Many calls are trivial in nature, yet others are critically important. Presently, there is no way of differentiating or ascertaining level of importance or urgency of an incoming phone call. At best, we presently have call display, identifying callers by name and number. Much valuable time is wasted answering trivial calls. Overabundance of trivial calls induces people to ignore calls, consequently missing many important ones. Urgent calls should obviously be answered with expediency. Many people are very difficult to contact, making repeated attempts to communicate with them by telephone frustrating. People too busy to answer the telephone may desire to communicate with specific callers at more convenient times. Existing mobile device privacy settings enable total blocking of all calls but lack ability to restrict calls from individuals. If you are preoccupied and anticipate an imminent call from an individual at an inopportune time, you may want to send them a temporary request to “not call” at the present time. One may wish to speak to another person but only about one specific topic. One may wish to not speak to an individual regarding a specific topic. Employees wishing to speak to superiors have little way of predicting optimal timing for telephone communication.

Limited screen-display area of modern wearable mobile devices drastically restricts ability to efficiently compose text messages, as there is no space on miniature displays for a functional input keyboard; small wearable mobile communication devices are more conducive to “touch to send” messages as opposed to texting. Texting between mobile devices is very popular but requires time, effort and electronic keyboard input on a device too small for most fingers to enter data accurately.

### FIELD OF THE INVENTION

The invention relates to a method of graphic selection, adjustment and manipulation, enabling enhanced communication on mobile devices by facilitating manual selection of variable data input representing various levels of call request priority, subsequently transmitted and displayed to a recipient.

### DESCRIPTION OF RELATED ART

Presently, there appears to be no means of indicating or interpreting level of priority of incoming or outgoing communication requests transmitted by means of mobile hand-held electronic devices. At best, incoming calls may display caller identification by name and number. The only alternative available is arduously typing and sending a detailed text message expressing priority; however, with numerous incoming text messages arriving simultaneously, many important messages hosting time-critical information may go un-noticed and consequently missed.

Prioritization of communication requests with added indication of reason for call request would be extremely useful to the present one point seven billion global cell phone users.

Numerous methods of relaying communication priority have been described by other inventors but most involve using complex systems of special communication channels (Toksvig, et al., U.S. Pat. No. 8,934,877); distinctive telephone ring tones requiring special controllers (Lee, U.S. Pat. No. 6,418,330); prior submission subscriber profiles stored in a database of information on web servers in order to function (Gorti, et al., U.S. Pat. No. 8,867,724); intermediate logic controllers to predetermine level of priority; call blocking to permit reception of emergency communications (Burgess, U.S. Pat. No. 6,359,970); systems requiring subscriber-defined special handling for calls (Groen, et al., U.S. Pat. No. 6,650,746); unfavorable requirement of disclosure of personal activity information prior to or during call (Klein, et al., U.S. Pat. No. 7,542,558); requirement of additional peripheral interface devices (Duncan, et al. U.S. Pat. No. 7,284,077); systems requiring electrically-integrated telecommunication function blocks (Teranishi, U.S. Pat. No. 6,937,880); priority-based phone call filtering by caller phone number (Varanasi U.S. Pat. No. 8,805,328).

The invention disclosed herein provides an inexpensive, simple, time-efficient method of effectively composing, transmitting, receiving, observing, interpreting and managing all possible types of priority call requests. The invention prototype is presently fully functional in the form of a mobile communication device software application and is ready for implementation.

### BRIEF SUMMARY OF THE INVENTION

The invention provides mobile communication device users a simple time-efficient method of composing and transmitting a communication request priority notification to a recipient. Selection of variable data input is accomplished by manual selection of predetermined settings, adjustment and manipulation of visual characteristics of graphic icons on a touch-screen display. Sender input data transmitted and displayed to a recipient indicates level of priority of communication request.

### BRIEF DESCRIPTION OF THE DRAWINGS

FIG. 1: Mobile device touch-screen display illustrating software application features.

FIG. 1 illustrates hand-held mobile device software application features on a touch-screen display 3 with software application functioning. Onscreen touch-sensitive buttons are labelled as “CONTACT” 1, “TOPIC” 2, “CALL ME” 4 and “NO CALL” 7. Touch-sensitive sliding control 5 is manually operated by touching and sliding a button 6 to translate position of the button 6. Once level of communication priority is defined by sliding the button 6 then “CALL ME” 4 button is touched to transmit the message to selected recipient. The message transmitted utilizes differentiated sizes and colors of graphics characters and proportional graphic icon in-fill to represent and display communication priority to recipient. Incoming messages are displayed by contact name 8.

FIG. 2: Mobile device screen display illustrating incoming communication priority request

A mobile device touch-screen with said software application functioning is illustrated in FIG. 2, displaying an incoming priority-based communication request from a remote user. A graphic character 10 indicates priority; the relative overall size, color and proportional extent of shaded area in-filled within the outlined graphics character 10 indicating priority level of communication request. Position of a button 6 also indicates level of priority. Onscreen labels portray sender identification 8 by name of contact and topic “TOPIC” 2 of communication requests. Touch-sensitive button “RESPOND” 12 activates a predetermined drop-down menu suggesting quick responses for easy selection. Touch-sensitive button “SEND” 13 activates message response data transmission to recipient.

### DETAILED DESCRIPTION OF THE INVENTION

The invention facilitates composition, transmission and display of priority-based communication requests between mobile communication devices by providing simple and time-efficient means to compose, select and transmit hybridized messages to a recipient. Priority (relative importance, urgency) of communication request is indicated to recipient on a touch-screen display using sender-selected, adjusted and manipulated graphics of variable size and color. Along with priority level, identification of sender and nature of communication request are also provided. With a couple taps on the touch-screen, a message can be sent to a recipient requesting them to call you. Displaying priority of the communication request empowers the recipient with choices of ignoring the request, if busy, or returning urgent calls immediately. Reason for the communication request is also relayed to recipient.

Using the invention is much faster and easier than arduously composing and repeatedly typing and sending text messages.

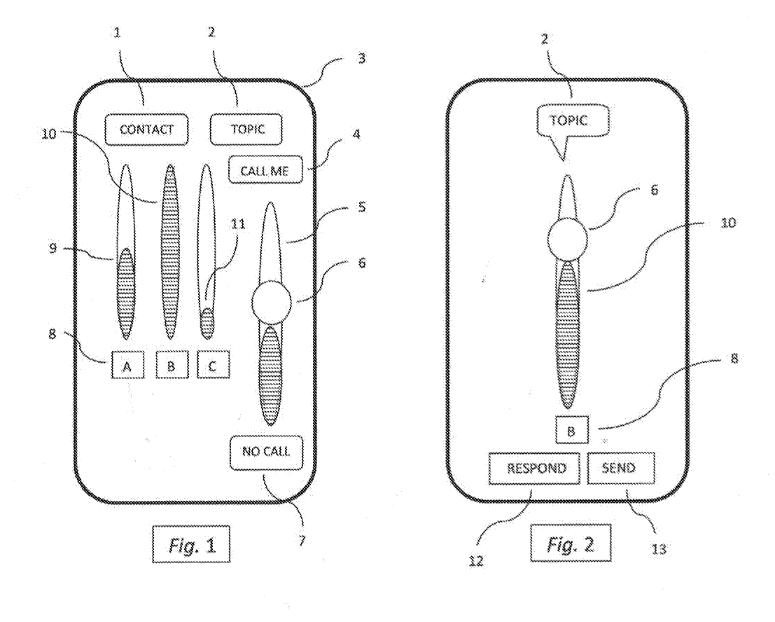

A touch-screen display on a hand-held mobile device is illustrated in FIG. 1 with software application functioning. Overall outlined shape of device touch-screen display 3 is illustrated. Touch-sensitive buttons onscreen are labelled as “CONTACT” 1 and “TOPIC” 2. When “CONTACT” 1 button is touched, a drop-down menu displays selections of personal contacts. Touching “TOPIC” 2 button activates a predetermined drop-down menu suggesting common topics of communication requests, precluding the arduous necessity of repeated typing identical messages by texting. Two additional onscreen touch-screen areas are labelled “CALL ME” 4 and “NO CALL” 7.

Touch-sensitive sliding control 5 is manually operated by touching and sliding button 6 towards one end or the other of sliding control 5. Button 6 is moved spatially to indicate priority of communication request. Sliding button 6 towards “NO CALL” 7 results in a low or “do not call” communication request setting. Sliding the button 6 towards “CALL ME” 4 end of sliding control 5 causes a high priority or urgent communication level being set. Adjustment of sliding control 5 by manipulating button 6 changes color and size of graphics characters intended to be transmitted to recipient. Once level of communication priority is defined then “CALL ME” 4 button is touched to transmit the message to a recipient, or multiple recipients simultaneously. The message transmitted displays varying sizes and colors of graphics characters to represent and display communication priority to recipient.

To place a priority-based communication request, select a personal contact by touching “CONTACT” 1 to select intended recipient from a drop-down list of contacts. Next, touch “TOPIC” 2 to select a communication topic from a drop-down menu of predetermined topics. Touch and slide the button 6 towards “CALL ME” 4 or “NO CALL” 7 fields of sliding control 5 to set communication priority high, medium or low. Press the “CALL ME” 4 button to initiate transmission of the message to recipient. The preferred embodiment is now operating as a functional software application with four priority settings of high, medium, low and don't call, represented by four different colors with four different sizes of graphic icons.

Recent incoming communication requests 9, 10, 11 in FIG. 1 from other users are displayed on the touch-screen device as variably-sized and/or variably in-filled colored graphics characters, the overall size, color or graphically in-filled proportion of which is interpreted to relay communication priority. Names of people that have sent communication requests to you are displayed onscreen as their contact names A,B,C 8. Swiping a finger across the contact name region of the touch-screen scrolls most-recent calls horizontally to reveal historic communication requests. Graphical representation of priority level of communication requests quickly makes prioritizing return communications greatly simplified. Scrolling through historic communication requests onscreen facilitates instant recognition of high priority requests while enabling delay of contact to those indicating less-important requests. Touching and holding any onscreen icons representing historic communication requests causes immediate initiation of a cell phone communication to the sender.

For example, contact “B” in FIG. 2 has sent a very high priority call request as indicated by substantial in-fill of the graphic character scale 10. In FIG. 1, contact “A” 8 has sent a medium-priority communication request and contact “C” 8 does not want to be called, as indicated by the low communication request priority setting received. In FIG. 2, topic of request “TOPIC” 2 is displayed over the graphic character scale 10; touching and holding the graphics character scale 10 initiates an immediate return call to sender.

The preferred embodiment facilitates designation of communication request priority by selection of predetermined and user-modifiable graphics characters using variables of size and color of graphics; however, other embodiments could easily be based upon variable data input by sender or displayed to recipient differentiated by: distinguishable shape of graphic icons, visual graphic intensity, spatial distribution of graphic icons, animation of graphic icons, variable sound frequency, sound clips, sound recordings, pitch, tone, number or amplitude of pulsed vibrations, light intensity, combinations of lights, selection of LED lights on a display screen, numeric representation, tactile sensation, electro-stimulation, olfactory sensation, brainwave patterns, text, voice command, mood, body temperature, gyroscopic motion sensing, emoticon representation, motion of body parts, speed of motion, taste, breath intensity, holographic selection, ultrasound, haptic feedback, quantum state or combinations thereof.

In another embodiment, a voice recognition system similar to the mobile device assistant SIRI of Apple Inc. could be used to audibly recognize and send priority communication requests.

This invention is now a functional mobile device software application useable on hand-held mobile devices; the application will be soon be useable on laptops, desktop computers, computer watches and other wearable communication devices.

What is claimed is:

1. A method of input, transmission and reception of data representing priority communication requests on an electronic device, the method comprising:
a means of selecting, adjusting and manipulating data input to indicate priority level of communication request,
with transmission of said input data to a remotely-located electronic device,
then displayed or otherwise conveyed to a recipient, thereby indicating priority of communication request.

2. The method of claim 1, whereby variable selections of data input by sender or displayed to recipient are differentiated on the basis of shape, size, or color of graphic icons, visual graphic intensity of graphic icons, spatial distribution of graphic icons, animation of graphic icons, representation by emoticons.

3. The method of claim 1, whereby variable selections of data input by sender or displayed to recipient are differentiated on the basis of light intensity, combinations of lights, selection of lights, color of lights, holographic selection.

4. The method of claim 1, whereby variable selections of data input by sender or displayed to recipient are differentiated audibly using variable sound frequencies, sound clips, sound recordings, pitch or tone.

5. The method of claim 1, whereby variable selections of data input by sender or displayed to recipient are differentiated on the basis of human senses of touch, feel, taste, smell, number or amplitude of pulsed vibrations, breath intensity, electro-stimulation.

6. The method of claim 1, whereby variable selections of data input by sender or displayed to recipient are differentiated using body part movements, mood, body temperature, biometrics, gyroscopic motion, brainwave patterns.

7. The method of claim 1, whereby variable selections of data input by sender or displayed to recipient are differentiated using voice command or pre-programmed software assistant.

8. The method of claim 1, whereby variable selections of data input by sender or displayed to recipient are differentiated using text or numeric representation.

9. The method of claim 1, whereby variable selections of data input by sender or displayed to recipient are differentiated on the basis of ultrasound, haptic feedback or quantum state.
